(19) United States
(12) Patent Application Publication
(10) Pub. No.: US 2023/0012114 A1
(43) Pub. Date: Jan. 12, 2023

(54) METHODS AND APPARATUS FOR SUPPORTING A RIBBON

(71) Applicant: CORNING INCORPORATED, CORNING, NY (US)

(72) Inventors: Tien San Chi, Taichung City (TW); Shawn Arvin Harris, Taipei City (TW); Yu Ying Tsai, Hsinchu (TW)

(21) Appl. No.: 17/783,475

(22) PCT Filed: Dec. 1, 2020
(86) PCT No.: PCT/US2020/062637

§ 371 Date: Jun. 8, 2022

Related U.S. Application Data
(60) Provisional application No. 62/946,501, filed on Dec. 11, 2019.

(51) Int. Cl. B24B 41/06

(52) U.S. Cl. CPC B24B 41/068

(57) ABSTRACT

A ribbon supporting apparatus includes a support surface defining a first plane. The ribbon supporting apparatus includes a first wall portion extending along a surface edge of the support surface. The first wall portion includes a first surface defining a second plane that is offset from the first plane. The first wall portion includes a first hardness. The ribbon supporting apparatus includes a second wall portion extending along the surface edge and includes a second surface attached to the first surface and a third surface defining a third plane. The second plane extends between the first plane and the third plane. The second wall portion includes a second hardness that is greater than the first hardness. Methods of supporting a ribbon are also provided.

### RELATED APPLICATION

This application claims the benefit of priority under 35 U.S.C. § 119 of U.S. Provisional Application Ser. No. 62/946,501 filed on Dec. 11, 2019, the content of which is relied upon and incorporated herein by reference in its entirety.

### FIELD

The present disclosure relates generally to methods for supporting a ribbon and, more particularly, to methods for supporting a ribbon with a ribbon supporting apparatus.

### BACKGROUND

During the manufacturing of a glass ribbon, a major surface of the glass ribbon may be polished. Known glass ribbons may comprise a planar or a non-planar shape. The glass ribbon may be supported by a support apparatus during the polishing process. However, different support apparatuses are used for differing shapes (e.g., planar or non-planar) of glass ribbons. Further, the glass ribbon is susceptible to inadvertent damage due to the glass ribbon contacting walls of the support apparatus. In addition, during the polishing, the support apparatus may be damaged and/or may experience wear, such that maintaining the support apparatus may be costly and time-consuming.

### SUMMARY

There are set forth methods of supporting a ribbon, comprising positioning the ribbon within a recess of a ribbon supporting apparatus. The recess may be defined between one or more walls. In some embodiments, the ribbon supporting apparatus can comprise one or more openings through which air can be evacuated, thus generating a negative pressure between the ribbon and the ribbon supporting apparatus. The negative pressure can assist in maintaining the ribbon in a fixed position relative to the ribbon supporting apparatus. In addition, the one or more walls of the ribbon supporting apparatus can comprise a plurality of wall portions that comprise differing hardness. A first wall portion may comprise a first hardness that is less than a second hardness of a second wall portion. As such, if the ribbon inadvertently contacts the first wall portion, damage to the ribbon may be avoided. Further, the second wall portion can shield the first wall portion, for example, during the polishing process. If the second wall portion sustains damage or wear, the second wall portion may be removable from the first wall portion and replaced with a different second wall portion. The replaceability of the second wall portion can further accommodate differing sizes and shapes of the ribbon. As such, the ribbon supporting apparatus can experience a longer lifespan while being able to accommodate different ribbons.

Embodiment 1. A ribbon supporting apparatus comprises a support surface defining a first plane. The ribbon supporting apparatus comprises a first wall portion extending along a surface edge of the support surface. The first wall portion comprises a first surface defining a second plane that is offset from the first plane. The first wall portion comprises a first hardness. The ribbon supporting apparatus comprises a second wall portion extending along the surface edge and comprising a second surface attached to the first surface and a third surface defining a third plane. The second plane extends between the first plane and the third plane. The second wall portion comprises a second hardness that is greater than the first hardness.

Embodiment 2. The ribbon supporting apparatus of embodiment 1, wherein the support surface comprises a third hardness that is less than the second hardness.

Embodiment 3. The ribbon supporting apparatus of any one of embodiments 1-2, wherein the support surface comprises a first opening spaced a first distance from the surface edge and a second opening spaced a second distance from the surface edge, the first distance greater than the second distance.

Embodiment 4. The ribbon supporting apparatus of any one of embodiments 1-3, wherein the first wall portion comprises a first edge extending along the surface edge, the first edge defining a first edge plane.

Embodiment 5. The ribbon supporting apparatus of embodiment 4, wherein the second wall portion comprises a second edge extending along the surface edge, the second edge defining a second edge plane that is offset from the first edge plane.

Embodiment 6. The ribbon supporting apparatus of embodiment 5, wherein the support surface is on a first side of the first edge plane and the second wall portion is on a second side of the first edge plane.

Embodiment 7. The ribbon supporting apparatus of any one of embodiments 1-6, further comprising a third wall portion extending along a second surface edge of the support surface. The third wall portion comprises a fourth surface defining a fourth plane that is offset from the first plane. The ribbon supporting apparatus comprises a fourth wall portion extending along the second surface edge and comprising a fifth surface attached to the fourth surface of the third wall portion and a sixth surface defining a fifth plane. The fourth plane extends between the first plane and the fifth plane.

Embodiment 8. The ribbon supporting apparatus of embodiment 7, wherein the second wall portion comprises a second wall height between the second surface of the second wall portion and the third surface of the second wall portion. The fourth wall portion comprises a fourth wall height between the fifth surface of the fourth wall portion and the sixth surface of the fourth wall portion.

Embodiment 9. The ribbon supporting apparatus of embodiment 8, wherein the second wall height is different than the fourth wall height.

Embodiment 10. A ribbon supporting apparatus comprises a support surface comprising a first opening spaced a first distance from a surface edge of the support surface and a second opening spaced a second distance from the surface edge. The first distance is greater than the second distance. The ribbon supporting apparatus comprises a first wall portion comprising a first edge extending along the surface edge. The first edge defines a first edge plane. The ribbon supporting apparatus comprises a second wall portion attached to the first wall portion and comprising a second edge extending along the surface edge. The second edge defines a second edge plane that is offset from the first edge plane.

Embodiment 11. The ribbon supporting apparatus of embodiment 10, wherein the support surface is on a first side of the first edge plane and the second wall portion is on a second side of the first edge plane.

Embodiment 12. The ribbon supporting apparatus of any one of embodiments 10-11, wherein the first wall portion comprises a first hardness and the second wall portion comprises a second hardness that is greater than the first hardness.

Embodiment 13. The ribbon supporting apparatus of embodiment 12, wherein the support surface comprises a third hardness that is less than the second hardness.

Embodiment 14. A method of supporting a ribbon comprises forming the ribbon comprising a first major surface that is convex and a second major surface that is concave. The method comprises positioning the ribbon on a support surface bordered by a first wall portion such that the second major surface faces away from the support surface. The method comprises calculating a ribbon height of the ribbon between the first major surface and the second major surface. The method comprises selecting a second wall portion such that the ribbon height is less than a sum of a first height of the first wall portion and a second height of the second wall portion. The method comprises attaching the second wall portion to the first wall portion. The method comprises polishing the second major surface of the ribbon.

Embodiment 15. The method of embodiment 14, wherein the positioning the ribbon on the support surface comprises attaching the ribbon to the support surface by generating a negative pressure at a plurality of locations of the support surface.

Embodiment 16. The method of any one of embodiments 14-15, wherein the attaching the second wall portion comprises positioning the second wall portion a distance apart from the ribbon such that a gap is formed between the second wall portion and the ribbon.

Embodiment 17. The method of any one of embodiments 14-16, wherein the attaching the second wall portion comprises positioning a second edge of the second wall portion offset from a first edge of the first wall portion, the first edge and the second edge facing the ribbon.

Embodiment 18. The method of any one of embodiments 14-17, further comprising detaching the second wall portion from the first wall portion and attaching a third wall portion to the first wall portion.

Embodiment 19. The method of any one of embodiments 14-18, wherein the selecting the second wall portion comprises selecting the second wall portion comprising a second hardness that is greater than a first hardness of the first wall portion.

Additional features and advantages of the embodiments disclosed herein will be set forth in the detailed description that follows, and in part will be clear to those skilled in the art from that description or recognized by practicing the embodiments described herein, including the detailed description which follows, the claims, as well as the appended drawings. It is to be understood that both the foregoing general description and the following detailed description present embodiments intended to provide an overview or framework for understanding the nature and character of the embodiments disclosed herein. The accompanying drawings are included to provide further understanding, and are incorporated into and constitute a part of this specification. The drawings illustrate various embodiments of the disclosure, and together with the description explain the principles and operations thereof.

### BRIEF DESCRIPTION OF THE DRAWINGS

These and other features, embodiments and advantages are better understood when the following detailed description is read with reference to the accompanying drawings, in which:

FIG. 1 schematically illustrates example embodiments of a ribbon supporting apparatus in accordance with embodiments of the disclosure;

FIG. 2 schematically illustrates example embodiments of a ribbon supported within a recess of a ribbon supporting apparatus in accordance with embodiments of the disclosure;

FIG. 3 illustrates a perspective view of example embodiments of a ribbon supporting apparatus in accordance with embodiments of the disclosure;

FIG. 4 illustrates a sectional view of example embodiments of a ribbon supporting apparatus along line 4-4 of FIG. 3 in accordance with embodiments of the disclosure;

FIG. 5 illustrates a sectional view of example embodiments of a glass ribbon along line 5-5 of FIG. 4 in accordance with embodiments of the disclosure;

FIG. 6 illustrates a sectional view of example embodiments of a ribbon supporting apparatus with a second wall portion being attached to a first wall portion in accordance with embodiments of the disclosure;

FIG. 7 illustrates a sectional view of example embodiments of a ribbon supporting apparatus with a second wall portion being detached from a first wall portion in accordance with embodiments of the disclosure; and

FIG. 8 illustrates a sectional view of example embodiments of a ribbon supporting apparatus with a second wall portion being attached to a first wall portion in accordance with embodiments of the disclosure.

### DETAILED DESCRIPTION

Embodiments will now be described more fully hereinafter with reference to the accompanying drawings in which example embodiments are shown. Whenever possible, the same reference numerals are used throughout the drawings to refer to the same or like parts. However, this disclosure may be embodied in many different forms and should not be construed as limited to the embodiments set forth herein.

The present disclosure relates to a ribbon supporting apparatus and methods for supporting a ribbon. Methods and apparatus for supporting a ribbon will now be described by way of example embodiments. In some embodiments, a ribbon 101 can be formed. For example, methods of supporting the ribbon 101 can comprise forming the ribbon 101 comprising a first major surface 103 that is convex and a second major surface 105 that is concave. In some embodiments, the ribbon 101 can comprise a glass-based material, for example, glasses and glass-ceramics, wherein glass-ceramics comprise one or more crystalline phases and an amorphous, residual glass phase. The ribbon 101 may comprise an amorphous material (e.g., glass) and optionally one or more crystalline materials (e.g., ceramic). In some embodiments, amorphous materials and glass-based materials may be strengthened, for example, by being chemically strengthened through ion-exchange of larger ions for smaller ions in one or more of the major surfaces 103, 105 of the ribbon 101. However, other strengthening methods known in the art, for example, thermal tempering, or utilizing a mismatch of the coefficient of thermal expansion between portions of the ribbon to create compressive stress and central tension regions, may be utilized to form strengthened ribbons. In some embodiments, a stress imbalance may be generated between the first major surface 103 and the second major surface 105, which can cause a bending moment within the ribbon 101. The bending moment can generate the non-planar shape of the ribbon 101, for example, with the first major surface 103 being convex and the second major surface 105 being concave. In some embodiments, the ribbon 101 can comprise soda-lime glass, alkali aluminosilicate glass, alkali-containing borosilicate glass, alkali-containing aluminoborosilicate glass, alkali-containing phosphosilicate glass, alkali-containing aluminophosphosilicate glass, alkali-free glass, etc.

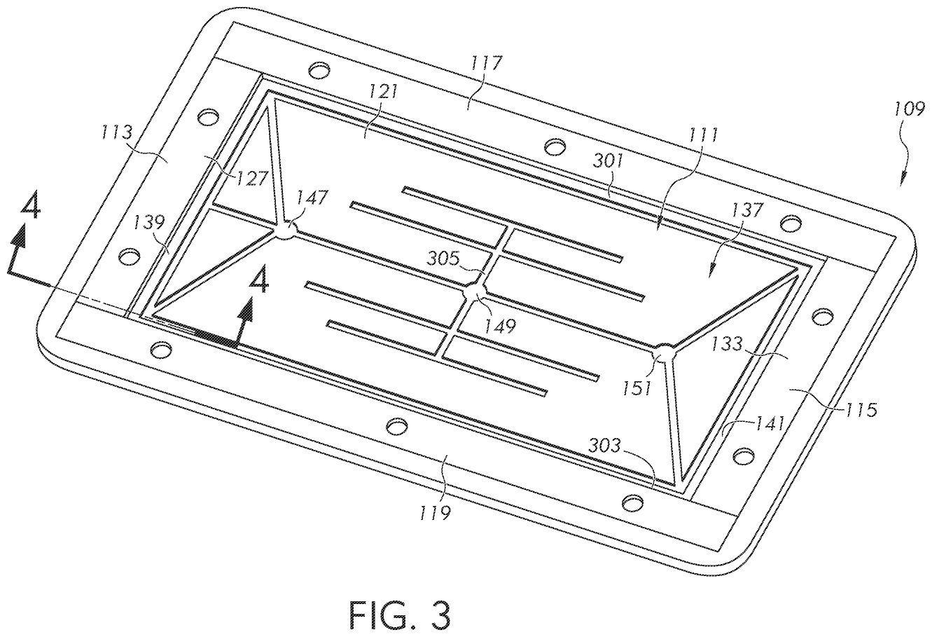

In some embodiments, following the formation of the ribbon 101, the ribbon 101 can be polished. To polish the ribbon 101, the ribbon 101 can be supported by a ribbon supporting apparatus 109. For example, in some embodiments, the ribbon supporting apparatus 109 can define a recess 111 that is sized to receive the ribbon 101. The recess 111 can be defined between one or more walls of the ribbon supporting apparatus 109, for example, a first wall 113, a second wall 115, a third wall 117 (e.g., illustrated in FIG. 3), and a fourth wall 119 (e.g., illustrated in FIG. 3). In some embodiments, the first wall 113 and the second wall 115 can be spaced apart with a support portion 121 extending between the first wall 113 and the second wall 115. In some embodiments, the first wall 113 can comprise one or more wall portions, for example, a first wall portion 125 and a second wall portion 127. The first wall portion 125 and the second wall portion 127 can comprise different materials, for example, different materials that comprise a different hardness. In some embodiments, the second wall 115 can be substantially identical to the first wall 113, for example, with the second wall 115 comprising a first wall portion 131 (e.g., identical to the first wall portion 125) and a second wall portion 133 (e.g., identical to the second wall portion 127).

In some embodiments, the support portion 121 can comprise a substantially planar support surface 137 upon which the ribbon 101 can rest. The support surface 137 can comprise one or more surface edges that can extend adjacent to the first wall portion 125 of the first wall 113 and the first wall portion 131 of the second wall 115. For example, the support surface 137 can comprise a surface edge 139 that forms an outer limit of the support surface 137 that is adjacent to the first wall portion 125. The support surface 137 can comprise an opposing second surface edge 141 that forms an outer limit of the support surface 137 that is adjacent to the first wall portion 131.

In some embodiments, the support surface 137 can comprise one or more openings that extend through the support surface 137, for example, between a first side 143 of the support surface 137 that borders the recess 111 and a second side 145 of the support surface 137 that is on an opposite side of the support surface 137 from the recess 111. In some embodiments, the one or more openings of the support surface 137 can comprise, for example, a first opening 147, a second opening 149, and a third opening 151. The first opening 147, the second opening 149, and the third opening 151 can define a passageway through which air can be removed from the recess 111 when the ribbon 101 is positioned within the recess 111. For example, the first major surface 103 can contact the support surface 137, and a negative air pressure can be generated through the first opening 147, the second opening 149, and the third opening 151. The negative air pressure can facilitate an attachment between the ribbon 101 and the support surface 137, thus limiting inadvertent movement of the ribbon 101 relative to the support surface 137.

In some embodiments, the first opening 147, the second opening 149, and the third opening 151 can be spaced at different distances from the surface edge 139. For example, the first opening 147 can be spaced a first distance 153 from the surface edge 139 (e.g., and from the first wall 113). The second opening 149 can be spaced a second distance 155 from the surface edge 139 (e.g., and from the first wall 113). In some embodiments, the second distance 155 may be greater than the first distance 153. In some embodiments, the third opening 151 can be spaced a third distance 157 from the surface edge 139 (e.g., and from the first wall 113). The third distance 157 may be greater than the first distance 153 and the second distance 155. In some embodiments, by having the first opening 147, the second opening 149, and the third opening 151 spaced at differing distances (e.g., the first distance 153, the second distance 155, and the third distance 157, respectively) from the surface edge 139, the ribbon 101 can be more securely supported relative to the support surface 137, for example, due to the negative pressure applied at different locations of the ribbon 101 through the first opening 147, the second opening 149, and the third opening 151. For example, the ribbon supporting apparatus 109 can receive ribbons of varying sizes and shapes. In some embodiments, the ribbon 101 may comprise a size that may be large enough to cover the first opening 147, the second opening 149, and the third opening 151. By positioning the first opening 147, the second opening 149, and the third opening 151 at a variety of locations of the support surface 137, the ribbon 101 may cover the openings, thus allowing for the ribbon to be attached to the support surface 137 via a vacuum pathway formed between the ribbon 101 and the support surface 137.

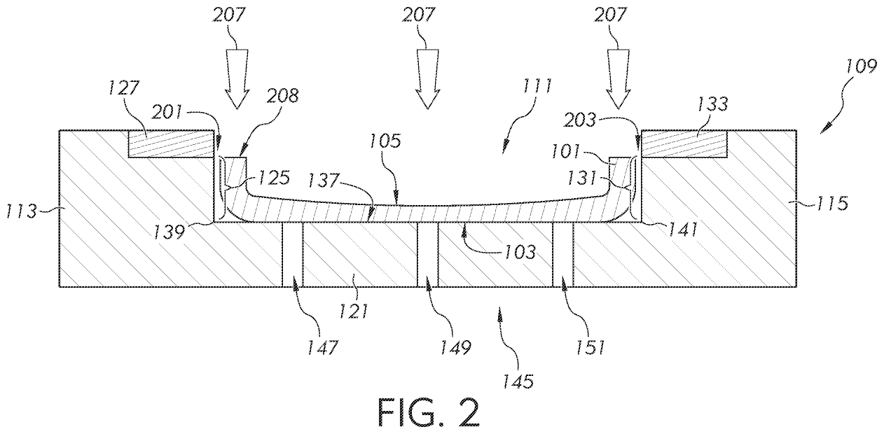

Referring to FIG. 2, the ribbon 101 can be positioned within the recess 111 and may be supported by the support surface 137. For example, in some embodiments, methods of supporting the ribbon 101 can comprise positioning the ribbon 101 on the support surface 137 bordered by the first wall portion 131 such that the second major surface 105 faces away from the support surface 137. For example, in some embodiments, when the ribbon 101 is positioned on the support surface 137, the first major surface 103 can face toward the support surface 137 and may be in contact with the support surface 137, and the second major surface 105 can face away from the support surface 137 and may not be in contact with the support surface 137. In some embodiments, positioning the ribbon 101 on the support surface 137 can comprise attaching the ribbon 101 to the support surface 137 by generating the negative pressure at a plurality of locations of the support surface 137. For example, the negative pressure can be generated at the first opening 147, the second opening 149, and the third opening 151. In some embodiments, a pressure source, for example, a vacuum, can be attached to the second side 145 of the support portion 121. The pressure source can be in fluid communication with the first opening 147, the second opening 149, and the third opening 151. In some embodiments, the pressure source can evacuate air from within the first opening 147, the second opening 149, and the third opening 151, which can generate the negative pressure at the plurality of locations of the ribbon 101. For example, the portion of the ribbon 101 that is adjacent to the first opening 147 can be attached to the support surface 137 via the negative pressure generated by first opening 147. Similarly, the portion of the ribbon 101 that is adjacent to the second opening 149 can be attached to the support surface 137 via the negative pressure generated by second opening 149. The portion of the ribbon 101 that is adjacent to the third opening 151 can be attached to the support surface 137 via the negative pressure generated by third opening 151. Accordingly, the ribbon 101 can be attached to the support surface 137 at a plurality of location, which can limit movement of the ribbon 101 relative to the support surface 137.

In some embodiments, when the ribbon 101 is positioned on the support surface 137, the ribbon 101 can be spaced apart from the first wall 113 and the second wall 115. For example, a first gap 201 may be defined between the first wall 113 (e.g., the first wall portion 125 and the second wall portion 127) and the ribbon 101, and a second gap 203 may be defined between the second wall 115 (e.g., the first wall portion 131 and the second wall portion 133) and the ribbon 101. The spacing between the ribbon 101 and the walls 113, 115 can limit contact between the ribbon 101 and the walls 113, 115, thus limiting damage to the ribbon 101. In some embodiments, due to the attachment of the ribbon 101 to the support surface 137, movement of the ribbon 101 may be limited, which can further limit the likelihood of contact between the ribbon 101 and the walls 113, 115. In some embodiments, methods of supporting the ribbon 101 can comprise polishing 207 the second major surface 105 of the ribbon 101. For example, in some embodiments, the polishing 207 can comprise removing surface imperfections in the second major surface 105 of the ribbon 101. The polishing 207 can comprise a mechanical polishing process using a rotating brush, for example, an abrasive rotating brush. In some embodiments, during the polishing 207, the rotating brush can contact the second major surface 105 and an edge surface 208 of the ribbon 101 (e.g., wherein the edge surface 208 extends between the first major surface 103 and the second major surface 105) to remove surface imperfections, decrease a thickness of the ribbon 101, and/or to create a desired edge strength of the ribbon 101.

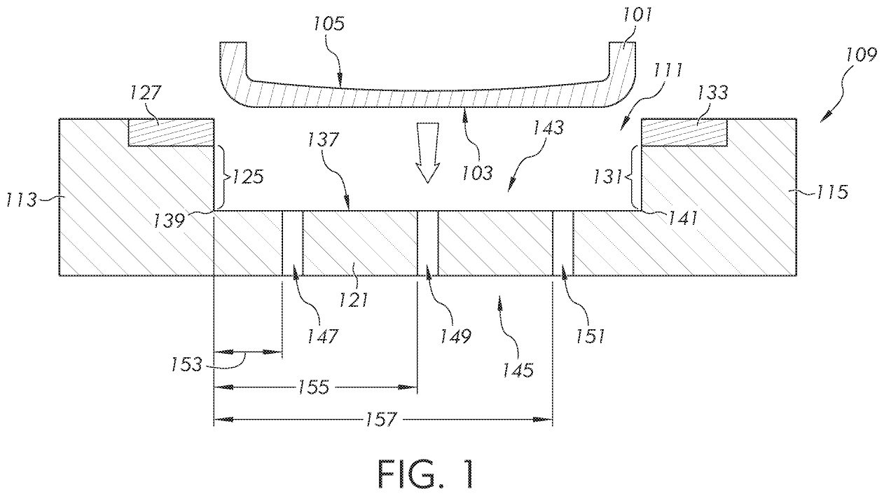

Referring to FIG. 3, a perspective view of the ribbon supporting apparatus 109 of FIGS. 1-2 is illustrated. In some embodiments, the recess 111 can be bordered by the first wall 113, the second wall 115, the third wall 117, and the fourth wall 119. The first wall 113 and the second wall 115 can be spaced apart from one another and positioned on opposing sides of the support portion 121. For example, the first wall 113 can extend along the surface edge 139 of the support surface 137, and the second wall 115 can extend along the second surface edge 141 of the support surface 137. The third wall 117 and the fourth wall 119 can be spaced apart from one another and positioned on opposing sides of the support portion 121. For example, the third wall 117 can extend along a third surface edge 301 of the support surface 137, and the fourth wall 119 can extend along a fourth surface edge 303 of the support surface 137. In some embodiments, the third wall 117 and the fourth wall 119 can extend between the first wall 113 and the second wall 115, with the first wall 113, the second wall 115, the third wall 117, and the fourth wall 119 forming a rectangular shape.

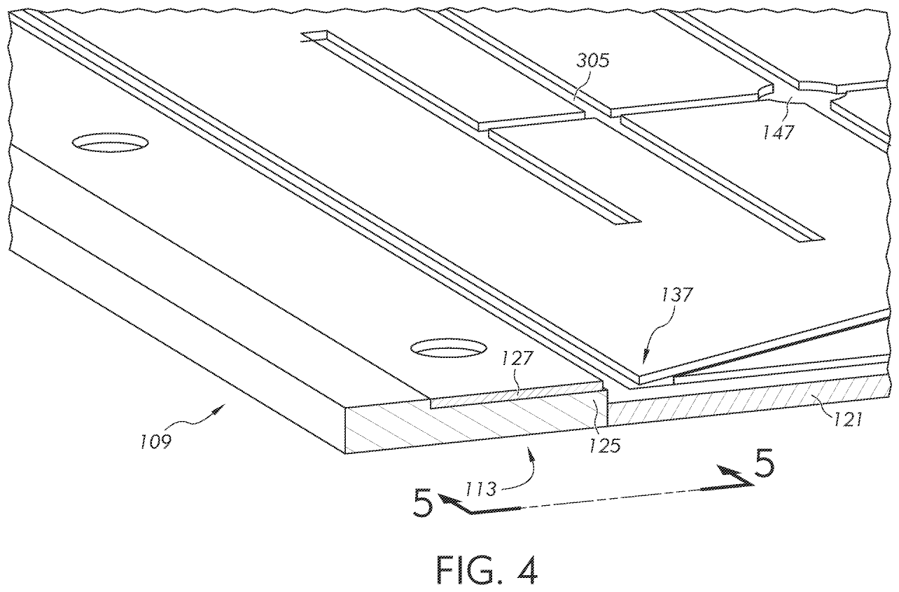

In some embodiments, the support portion 121 can comprise one or more support channels 305 to facilitate the negative pressure generation and improve the attachment of the ribbon 101 to the support surface 137. For example, FIG. 4 illustrates a sectional view of the ribbon supporting apparatus 109 along line 4-4 of FIG. 3. Referring to FIGS. 3-4, the one or more support channels 305 can comprise grooves, indentations, etc. formed in the support surface 137. The support channels 305 can extend from the first opening 147, the second opening 149, and/or the third opening 151. In some embodiments, the one or more support channels 305 can extend from a center of the support surface 137 toward the outer edges of the support surface 137, for example, toward one or more of the surface edge 139, the second surface edge 141, the third surface edge 301, or the fourth surface edge 303. In some embodiments, the ribbon supporting apparatus 109 can receive one or more ribbons 101 of varying shapes and/or sizes. To ensure attachment of the one or more ribbons 101 of varying shapes and/or sizes to the support surface 137 when the one or more ribbons 101 are received within the recess 111, the one or more support channels 305 can increase the number of locations at which a negative pressure can be generated. For example, the one or more support channels 305 may be in fluid communication with the first opening 147, the second opening 149, and the third opening 151. When air is evacuated from the first opening 147, the second opening 149, and the third opening 151 to generate the negative pressure, air may likewise be partially evacuated from the one or more support channels 305. Due to the ribbon 101 contacting the support surface 137, the negative pressure generated at the first opening 147, the second opening 149, the third opening 151, and the one or more support channels 305 may facilitate attachment of the ribbon 101 to the support portion 121 at the first opening 147, the second opening 149, the third opening 151, and the one or more support channels 305.

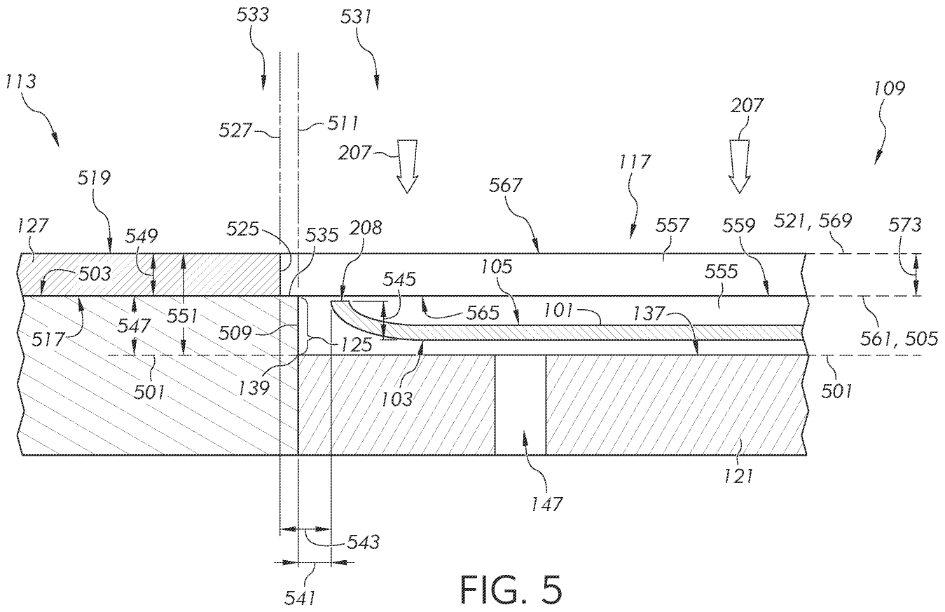

Referring to FIG. 5, a sectional view of the first wall 113 of the ribbon supporting apparatus 109 is illustrated with the ribbon 101 supported on the support surface 137. In some embodiments, the support surface 137 can define a first plane 501. In some embodiments, the first wall portion 125 can comprise a first surface 503 defining a second plane 505 that may be offset from the first plane 501. For example, in some embodiments, the first wall portion 125 and the second wall portion 127 can comprise different materials and may be separately attached. The second wall portion 127 can face the first surface 503 of the first wall portion 125, with the second wall portion 127 attached to and/or in contact with the first surface 503. In some embodiments, the first surface 503 can comprise a ledge upon which the second wall portion 127 can be supported. In some embodiments, the second plane 505 may be offset from the first plane 501, with the second plane 505 extending substantially parallel to the first plane 501. In some embodiments, the first wall portion 125 can comprise a first edge 509 that extends along the surface edge 139. For example, the first edge 509 can face the recess 111, wherein an axis extending from a center of the recess 111 toward the first wall portion 125 may intersect the first edge 509 prior to intersecting other portions of the first wall portion 125. The first edge 509 can therefore define an outermost boundary of the first wall portion 125 that borders the recess 111 and the surface edge 139. In some embodiments, the first edge 509 can define a first edge plane 511.

In some embodiments, the second wall portion 127 can be attached to the first wall portion 125. For example, the second wall portion 127 can be attached to the first wall portion 125 in several ways, for example, by mechanical fasteners, adhesives, etc. In some embodiments, when the second wall portion 127 is attached to the first wall portion 125 by one or more mechanical fasteners, the second wall portion 127 can be detached from and separated from the first wall portion 125. In this way, the second wall portion 127 can be selectively removed from the first wall portion 125 and replaced. In some embodiments, the second wall portion 127 can extend along the surface edge 139 and can comprise a second surface 517 that is attached to the first surface 503, and a third surface 519 defining a third plane 521. In some embodiments, the second surface 517 can face the first surface 503 and, when the second wall portion 127 is attached to the first wall portion 125, the second surface 517 can contact the first surface 503. For example, in some embodiments, the first surface 503 and the second surface 517 can have substantially matching shapes. For example, as illustrated in FIG. 5, the first surface 503 and the second surface 517 can comprise planar shapes, though, in some embodiments, the first surface 503 and the second surface 517 can comprise non-planar shapes. In some embodiments, the second plane 505 can extend between the first plane 501 and the third plane 521. For example, the third plane 521 may be offset from the first plane 501 and the second plane 505. The first plane 501 and the third plane 521 may be located on opposite sides of the second plane 505. In some embodiments, the third plane 521 may extend substantially parallel to the first plane 501 and the second plane 505.

In some embodiments, the second wall portion 127 can comprise a second edge 525 that extends along the surface edge 139. For example, the second edge 525 can face the recess 111, wherein an axis extending from a center of the recess 111 toward the second wall portion 127 may intersect the second edge 525 prior to intersecting other portions of the second wall portion 127. The second edge 525 can therefore define an outermost boundary of the second wall portion 127 that borders the recess 111 and the surface edge 139. In some embodiments, the second edge 525 can define a second edge plane 527 that may be offset from the first edge plane 511. For example, in some embodiments, the second edge plane 527 can extend substantially parallel to the first edge plane 511, with the second edge plane 527 spaced a distance apart from the first edge plane 511. The first edge 509 can therefore be offset from the second edge 525. In some embodiments, by being offset, the first edge plane 511 may not intersect the second wall portion 127. In some embodiments, the second edge 525 may be recessed from the first edge 509, such that the second edge plane 527 can intersect the first wall portion 125. The first edge plane 511 may therefore be positioned in closer proximity to the recess 111 than the second edge plane 527. For example, in some embodiments, the support surface 137 may be on a first side 531 of the first edge plane 511 and the second wall portion 127 may be on a second side 533 of the first edge plane 511. The first surface 503 of the first wall portion 125 may therefore comprise an uncovered portion 535 that may not be covered by and/or in contact with the second wall portion 127. Rather, the second edge 525 of the second wall portion 127 can be recessed from the first edge 509 of the first wall portion 125, thus leaving the uncovered portion 535 of the first surface 503 not covered by the second wall portion 127.

In some embodiments, one or more of the support surface 137, the first wall portion 125, or the second wall portion 127 can comprise materials that comprise a differing hardness. For example, the first wall portion 125 can comprise a first hardness, and the second wall portion 127 can comprise a second hardness that is greater than the first hardness. In some embodiments, the differing hardness of the first wall portion 125 and the second wall portion 127 can extend the lifetime of the ribbon supporting apparatus 109. For example, in some embodiments, due to the proximity of the first wall portion 125 to the ribbon 101, the first hardness of the first wall portion 125 may be lower than the second hardness of the second wall portion 127 to reduce the likelihood of damage to the ribbon 101 if the ribbon 101 inadvertently contacts the first wall portion 125. However, because the relatively lower first hardness of the first wall portion 125, the first wall portion 125 may be susceptible to damage during the polishing 207 process, for example, due to a polishing brush contacting the first wall portion 125. To protect the first wall portion 125, the second wall portion 127 can comprise the second hardness that is greater than the first hardness. The second hardness of the second wall portion 127 may be less susceptible to damage in the event of the polishing brush contacting the second wall portion 127 during the polishing 207. As such, due to the second wall portion 127 covering the first wall portion 125, the second wall portion 127 can protect the first wall portion 125 during the polishing 207, thus lengthening the lifetime of the first wall portion 125 and the ribbon supporting apparatus 109. In some embodiments, the first wall portion 125 can comprise a resin material, while the second wall portion 127 can comprise a harder material, for example, a metal material (e.g., steel), a glass fiber material, polyoxybenzylmethylenglycolanhydride material, etc.

In some embodiments, benefits may arise from avoiding contact between the polishing brush and the second wall portion 127. For example, contact between the polishing brush and the second wall portion 127 can damage one or more of the polishing brush or the second wall portion 127, thus reducing the lifetime of the polishing brush and/or the second wall portion 127. As such, the second wall portion 127 may be recessed from the first wall portion 125. For example, the support surface 137 and, thus, the ribbon 101, may be on the first side 531 of the first edge plane 511, and the second wall portion 127 may be on the second side 533 of the first edge plane 511. The uncovered portion 535 of the first surface 503 may therefore represent a portion of the first surface 503 that is not covered by the second wall portion 127. Due to the second edge 525 of the second wall portion 127 being recessed from the first edge 509 of the first wall portion 125, contact between the polishing brush and the second edge 525 may be limited. For example, in some embodiments, a first distance 541 can separate the ribbon 101 from the first edge plane 511, while a second distance 543 can separate the ribbon 101 from the second edge plane 527. The first distance 541 may be less than the second distance 543. As a result, during the polishing 207, the polishing brush may contact the second major surface 105 and/or the edge surface 208, but, due to the second distance 543 being greater than the first distance 541, the likelihood of contact between the polishing brush and the second edge 525 may be reduced.

In some embodiments, to further reduce the likelihood of damage to the ribbon 101, the support surface 137 can comprise a third hardness that may be less than the second hardness of the second wall portion 127. For example, when the ribbon 101 is received within the recess 111, the first major surface 103 may contact the support surface 137 of the support portion 121. In some embodiments, the third hardness of the support surface 137 may be low enough to not cause inadvertent damage (e.g., scratching, etc.) to the first major surface 103 when the ribbon 101 is supported by the support surface 137. In some embodiments, the support surface 137 may comprise the same material as the first wall portion 125 (e.g., a resin), though, the support surface 137 and the first wall portion 125 can comprise different materials.

In some embodiments, a height of the first wall portion 125 and the second wall portion 127 can be chosen based on a ribbon height 545. In some embodiments, the ribbon height 545 can comprise a maximum distance deviation between the first major surface 103 and one or more of the second major surface 105 or the edge surface 208. For example, in some embodiments, the ribbon 101 may be non-planar (e.g., as illustrated in FIG. 5) and may comprise a bend, a curved edge, etc. The non-planar ribbon 101 can comprise the ribbon height 545 measured between the first major surface 103 and the edge surface 208. In some embodiments, the ribbon 101 may be substantially planar, and may not comprise a bend, a curved edge, etc. The ribbon height 545 of the planar ribbon can therefore comprise a thickness of the ribbon, wherein the thickness of the ribbon may be measured between the first major surface 103 and the second major surface 105.

In some embodiments, depending on the ribbon height 545, the second wall portion 127 may be chosen such that a sum of the height of the first wall portion 125 and the second wall portion 127 may be greater than the ribbon height 545. For example, the first wall portion 125 can comprise a first height 547 between the first plane 501 and the first surface 503. The first major surface 103 can extend adjacent to the first plane 501 (e.g., along which the support surface 137 extends) when the ribbon 101 is supported on the support surface 137. In some embodiments, the first height 547 can be measured along an axis that is perpendicular to the first surface 503. In some embodiments, the second wall portion 127 can comprise a second height 549 between the second surface 517 of the second wall portion 127 and the third surface 519 of the second wall portion 127. The second height 549 can be measured along an axis that is substantially parallel to an axis along which the first height 547 is measured. In some embodiments, a sum of the first height 547 and the second height 549 can comprise a first wall height 551 of the first wall 113, wherein the first wall height 551 may be measured between the first plane 501 and the third surface 519 of the second wall portion 127. In some embodiments, the first wall height 551 may be greater than the ribbon height 545, for example, to provide adequate protection to the first wall portion 125 such that, during the polishing 207, the first wall portion 125 may not be damaged by the rotating brush. In some embodiments, a difference between the first wall height 551 and the ribbon height 545 may be greater than or equal to about 1 millimeter (mm). For example, when the ribbon height 545 is about 1.5 mm, then the first wall height 551 may be within a range from about 2.5 mm to about 4.5 mm. In some embodiments, the first wall height 551 can be adjusted. For example, the second wall portion 127 can be detached and removed from the first wall portion 125, and the second wall portion 127 can be replaced with a different second wall portion comprising a second height that is different than the second height 549.

FIG. 5 illustrates the third wall 117 in the background behind the ribbon 101 as viewed from line 4-4 of FIG. 4. The third wall 117 can be similar in some respects to the first wall 113. For example, the third wall 117 can comprise a third wall portion 555 and a fourth wall portion 557. The third wall portion 555 can be substantially identical to the first wall portion 125 of the first wall 113, and the fourth wall portion 557 can be substantially identical to the second wall portion 127 of the first wall 113. For example, the third wall portion 555 and the fourth wall portion 557 can extend along a surface edge (e.g., the third surface edge 301 of FIG. 3) of the support surface 137. In some embodiments, the third wall portion 555 can comprise a fourth surface 559 that can define a fourth plane 561. In some embodiments, the fourth plane 561 may be offset from the first plane 501. For example, in some embodiments, the fourth plane 561 may be co-planar with the second plane 505. In some embodiments, the fourth wall portion 557 can comprise a fifth surface 565 attached to the fourth surface 559 of the third wall portion 555 and a sixth surface 567 defining a fifth plane 569. The fifth surface 565 can be attached to the fourth surface 559 similar to the attachment of the second wall portion 127 to the first wall portion 125. For example, the fifth surface 565 can be attached to the fourth surface 559 by mechanical fasteners, adhesives, etc. In some embodiments, the fourth plane 561 can extend between the first plane 501 and the fifth plane 569. For example, the fifth plane 569 may be offset from the fourth plane 561 and from the first plane 501. In some embodiments, the fourth plane 561 and the fifth plane 569 may be substantially parallel.

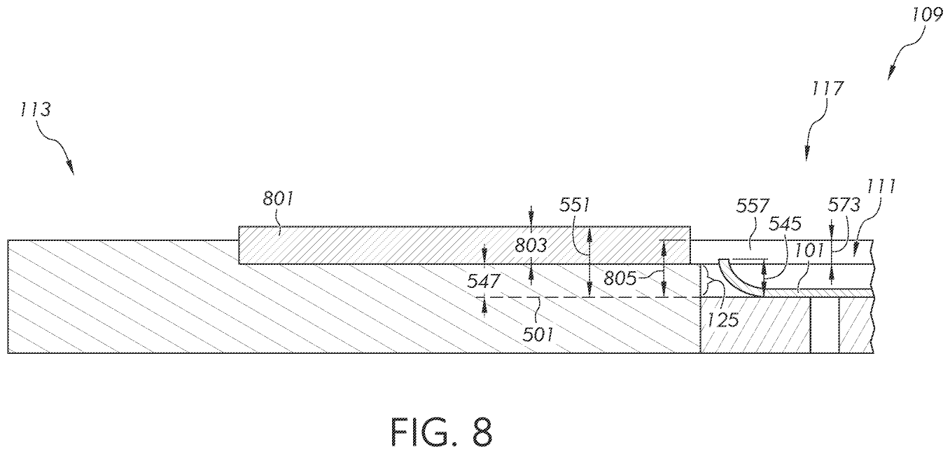

In some embodiments, the fourth wall portion 557 can comprise a fourth height 573 between the fifth surface 565 of the fourth wall portion 557 and the sixth surface 567 of the fourth wall portion 557. In some embodiments, depending on the shape and/or size of the ribbon 101, the fourth height 573 can be the same as or different than the second height 549. For example, in some embodiments, the ribbon 101 can comprise four edges, with some or all of the four edges comprising the same shape. In some embodiments, one or more of the edges of the ribbon 101 can comprise a flat, planar shape, and one or more of the edges of the ribbon 101 can comprise a non-planar, curved shape (e.g., similar to the shape of the first major surface 103, the second major surface 105, and the edge surface 208 of the ribbon 101 in FIG. 5). If the edge of the ribbon 101 that borders the first wall 113 and the edge of the ribbon 101 that borders the third wall 117 comprise the same shape and/or dimension (e.g., with the same ribbon height 545), then the first wall 113 and the third wall 117 can comprise the same wall height. For example, as illustrated in FIG. 5, the second height 549 of the second wall portion 127 may be the same as the fourth height 573 of the fourth wall portion 557. However, in some embodiments (e.g., as illustrated in FIG. 8), the second height 549 may be different than the fourth height 573, such that the first wall 113 and the third wall 117 may comprise different wall heights. The second height 549 differing from the fourth height 573 may be due, in part, to the ribbon 101 comprising a different shape and/or different ribbon height 545 adjacent to the first wall 113 and the third wall 117. In some embodiments, the other walls (e.g., the second wall 115 and the fourth wall 119) can comprise similar modifications (e.g., differing wall heights or the same wall heights as compared to one another, as well as compared to the first wall 113 and the third wall 117) depending on the shape of the ribbon 101.

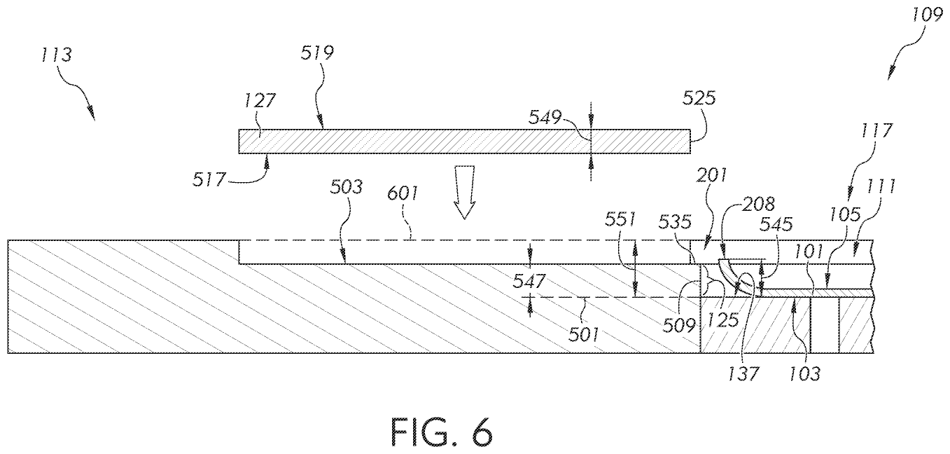

Referring to FIG. 6, in some embodiments, methods of supporting the ribbon 101 can comprise calculating the ribbon height 545 of the ribbon 101 between the first major surface 103 and the second major surface 105. For example, in some embodiments, prior to the attachment of the second wall portion 127 to the first wall portion 125, the ribbon height 545 of the ribbon 101 can be calculated. The ribbon height 545 can be calculated prior to the insertion of the ribbon 101 into the recess 111 or after the ribbon 101 has been inserted into the recess 111 and is supported by the support surface 137. In some embodiments, the ribbon height 545 can be calculated by a measurement device, for example, a sensor (e.g., a thermal sensor that senses a thickness), a camera, a ruler, etc. In some embodiments, the ribbon height 545 can be calculated based on known criteria, for example, based on process parameters that produce a ribbon with known dimensions. In some embodiments, the ribbon height 545 of the ribbon 101 may be equal to a thickness of the ribbon 101 between the first major surface 103 and the second major surface 105, for example, when one or more edges of the ribbon 101 comprise a planar shape. In some embodiments, the ribbon height 545 of the ribbon 101 may be different at different edges of the ribbon 101, for example, when one or more edges of the ribbon 101 comprise the planar shape, and one or more edges of the ribbon 101 comprise the non-planar shape (e.g., similar to the edge of the ribbon 101 illustrated in FIG. 5).

In some embodiments, methods of supporting the ribbon 101 can comprise selecting the second wall portion 127 such that the ribbon height 545 may be less than a sum of the first height 547 of the first wall portion 125 and the second height 549 of the second wall portion 127. For example, the ribbon height 545 may be calculated prior to the selection of the second wall portion 127. In some embodiments, benefits may accrue from the sum of the first height 547 and the second height 549 (e.g., comprising the first wall height 551) being larger than the ribbon height 545. For example, as set forth relative to FIG. 5, the second wall portion 127 can limit damage to the first wall portion 125 during the polishing process if the rotating brush contacts the first wall 113. In some embodiments, dashed lines 601 can represent a position of the second wall portion 127 when the second wall portion 127 is attached to the first wall portion 125. For example, the dashed lines 601 can represent the location of the third surface 519 of the second wall portion 127 when the second wall portion 127 is in attachment with the first wall portion 125. In some embodiments, the first height 547 of the first wall portion 125 may be static and may not be readily changeable. As such, to adjust the first wall height 551, the second wall portion 127 can be chosen based on the second height 549, such that the sum of the first height 547 and the second height 549 is greater than the ribbon height 545.

In some embodiments, selecting the second wall portion 127 can comprise selecting the second wall portion 127 comprising a second hardness that is greater than the first hardness of the first wall portion 125. For example, as set forth above relative to FIG. 5, a benefit of the second wall portion 127 arises from the second wall portion 127 protecting the first wall portion 125 during the polishing. For example, the first wall portion 125 may comprise the first hardness. The first hardness of the first wall portion 125 may be chosen such that, if the ribbon 101 contacts the first wall portion 125, damage to the ribbon 101 may be avoided. In some embodiments, the ribbon 101 may be more likely to contact the first wall portion 125 during insertion of the ribbon 101 into the recess 111 and/or removal of the ribbon 101 from the recess 111. While the first wall portion 125 may comprise the first hardness that is relatively low in comparison to the second hardness of the second wall portion 127, the first wall portion 125 may be more susceptible to damage during the polishing 207, for example, due to the polishing brush contacting the first wall portion 125. To shield the first wall portion 125, which can reduce damage to the first wall portion 125 and increase the longevity of the first wall portion 125, the second wall portion 127 can be selected comprising the second hardness that is greater than the first hardness. By comprising the second hardness, the second wall portion 127 may shield the first wall portion 125 during the polishing 207, due to the second wall portion 127 being more resistant to damage from the polishing brush than the first wall portion 125. As such, in some embodiments, if the polishing brush contacts the first wall 113, the first wall portion 125 may be protected by the second wall portion 127, thus lengthening the lifespan of the ribbon supporting apparatus 109. In some embodiments, if the second wall portion 127 sustains damage (e.g., due to wear and tear, due to contact by the polishing brush, etc.), the second wall portion 127 can be detached from the first wall portion 125 and replaced.

In some embodiments, methods of supporting the ribbon 101 can comprise attaching the second wall portion 127 to the first wall portion 125. For example, after the second wall portion 127 has been selected based on one or more of the second height 549 or the second hardness, the second wall portion 127 can be attached to the first wall portion 125. The second wall portion 127 can be attached in several ways, for example, with mechanical fasteners, adhesives, etc. In some embodiments, by attaching the second wall portion 127 to the first wall portion 125 with mechanical fasteners, the second wall portion 127 can be selectively removed and replaced. With the second wall portion 127 attached to the first wall portion 125, the second wall portion 127 is limited from inadvertently moving relative to the first wall portion 125.

In some embodiments, the attaching the second wall portion 127 can comprise positioning the second wall portion 127 a distance apart from the ribbon such that a gap (e.g., the first gap 201) is formed between the second wall portion 127 and the ribbon 101. For example, the second wall portion 127 can be attached to the first wall portion 125 prior to the insertion of the ribbon 101 into the recess 111, or after the insertion of the ribbon 101 into the recess 111. In some embodiments, due to the second hardness of the second wall portion 127, benefits may accrue from limiting contact between the ribbon 101 and the second wall portion 127. For example, to avoid inadvertent damage to the ribbon 101, the first gap 201 can be defined between an edge of the ribbon 101 and the second wall portion 127. In some embodiments, the attaching the second wall portion 127 can comprise positioning the second edge 525 of the second wall portion 127 offset from the first edge 509 of the first wall portion 125, with the first edge 509 and the second edge 525 facing the ribbon 101. For example, the second edge 525 can be recessed from the first edge 509, such that a distance between an edge of the ribbon 101 and the second edge 525 may be greater than a distance between the edge of the ribbon 101 and the first edge 509. In some embodiments, due to the second edge 525 being offset from the first edge 509, the uncovered portion 535 of the first wall portion 125 may extend between the first edge 509 and the second edge 525. In some embodiments, by offsetting the second edge 525 from the first edge 509, the likelihood of contact between the polishing brush during the polishing 207 and the second wall portion 127 (e.g., the second edge 525 of the second wall portion 127) may be reduced. For example, while the polishing brush may polish the second major surface 105 and the edge surface 208 at the edge of the ribbon 101, the polishing brush may inadvertently extend beyond the edge surface 208 at the edge of the ribbon 101, for example, by extending toward the second edge 525. By providing the first gap 201 between the edge of the ribbon 101 and the second wall portion 127, the likelihood of contact between the second wall portion 127 and the polishing brush may be reduced, and damage to one or more of the second wall portion 127 and/or the polishing brush may be avoided.

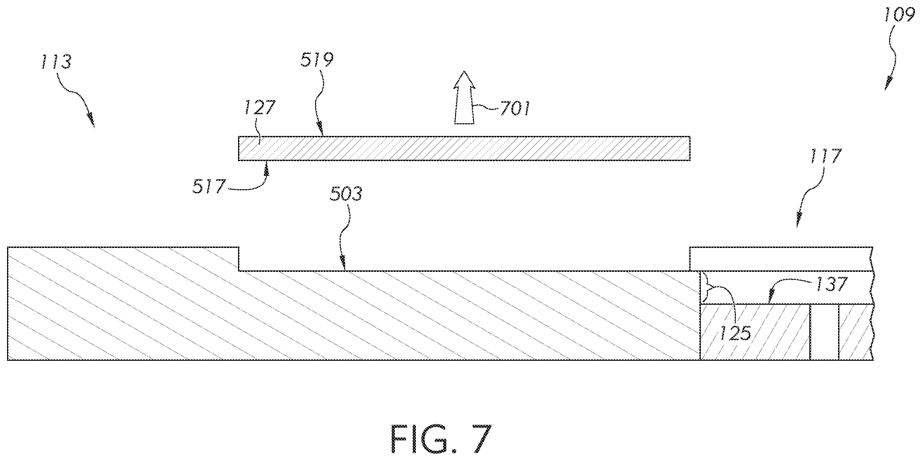

Referring to FIG. 7, in some embodiments, methods of supporting the ribbon 101 can comprise detaching the second wall portion 127 from the first wall portion 125 and attaching a third wall portion 801 (e.g., illustrated in FIG. 8) to the first wall portion 125. For example, in some embodiments, following the attachment of the second wall portion 127 to the first wall portion 125 (e.g., illustrated in FIG. 6), polishing 207 of the ribbon 101 may occur. In some embodiments, polishing 207 may be repeated several times with different ribbons (e.g., with the ribbon 101 being polished first, then removed, then a different ribbon placed in the recess 111 and polished, etc.), with the second wall portion 127 remaining attached to the first wall portion 125. In some embodiments, it may be beneficial to remove and replace the second wall portion 127. For example, during the polishing 207, the second wall portion 127 may become damaged (e.g., due to contact between the polishing brush and the second wall portion 127). In addition, or in the alternative, in some embodiments, the ribbon 101 may be replaced with a ribbon comprising a different size or shape. A differently sized second wall portion can replace the second wall portion 127 to accommodate the ribbon comprising the different size or shape. In some embodiments, the second wall portion 127 can be detached from the first wall portion 125 by removing the mechanical fasteners. The second wall portion 127 can then be moved in a removal direction 701 away from the first wall portion 125, thus exposing the first surface 503 to which a different second wall portion can be attached.

Referring to FIG. 8, in some embodiments, methods of supporting the ribbon 101 can comprise attaching a third wall portion 801 to the first wall portion 125. For example, in some embodiments, the third wall portion 801 can be selected similar to how the second wall portion may be selected (e.g., as illustrated in FIGS. 6-7). For example, the ribbon height 545 of the ribbon 101 can initially be calculated. The third wall portion 801 can be selected such that the ribbon height 545 may be less than a sum of the first height 547 of the first wall portion 125 and a third height 803 of the third wall portion 801. In some embodiments, the third height 803 can be greater than or less than the second height 549 (e.g., illustrated in FIG. 5), for example, depending on the ribbon height 545 of the ribbon 101. For example, for a larger ribbon height 545 at an edge of the ribbon 101 bordering the first wall 113, the first wall 113 can comprise the third wall portion 801 comprising the third height 803. For a smaller ribbon height 545 at an edge of the ribbon 101 bordering the first wall 113, the first wall 113 can comprise the second wall portion 127 comprising the second height 549, which is less than the third height 803. As such, the first wall 113 can be adjusted in height by replacing the second wall portion 127 with wall portions of differing sizes, for example, the third wall portion 801. In some embodiments, the third wall portion 801 can comprise a hardness (e.g., a third hardness) that may be greater than the first hardness of the first wall portion 125. The third wall portion 801 can then be attached to the first wall portion 125, for example, with mechanical fasteners, adhesives, etc. In some embodiments, the third wall portion 801 can be positioned relative to the first wall portion 125 such that the first gap 201 may be formed between the third wall portion 801 and the ribbon 101.

In some embodiments, the third height 803 of the third wall portion 801 may be different than the fourth height 573 of the fourth wall portion 557. For example, in comparison to the embodiments of FIGS. 5-7 wherein the second height 549 of the second wall portion 127 is equal to the fourth height 573 of the fourth wall portion 557, in some embodiments, the wall heights of one or more of the first wall 113, the second wall 115, the third wall 117, or the fourth wall 119 may be different. For example, as illustrated in FIG. 8, the first wall 113, comprising the third wall portion 801 attached to the first wall portion 125, can comprise the first wall height 551 that may be greater than a third wall height 805 of the third wall 117. In some embodiments, the third height 803 of the third wall portion 801 may be less than the fourth height 573 of the fourth wall portion 557, such that the first wall height 551 may be less than the third wall height 805. Accordingly, based on the size and shape of the ribbon 101 and/or damage to portions of the first wall 113, the second wall 115, the third wall 117, and/or the fourth wall 119, portions of one or more of the first wall 113, the second wall 115, the third wall 117, or the fourth wall 119 may be replaced. In addition, during the replacement of these portions, the heights of one or more of the first wall 113, the second wall 115, the third wall 117, or the fourth wall 119 can be altered to accommodate for differing sizes and/or shapes of ribbons.

Relative to FIGS. 5-8, the structure of the first wall 113 and methods of selecting, attaching, and detaching a portion (e.g., the second wall portion 127 and the third wall portion 801) of the first wall 113 were discussed. However, in some embodiments, the foregoing discussion of the first wall 113 relative to FIGS. 5-8 may be applicable to the second wall 115, the third wall 117, and the fourth wall 119. For example, in some embodiments, the second wall 115, the third wall 117, and the fourth wall 119 may be substantially identical to the first wall 113. The second wall 115, the third wall 117, and the fourth wall 119 may comprise a wall portion comprising a first hardness, wherein the wall portion may be equivalent to the first wall portion 125 of the first wall 113. In some embodiments, second wall 115, the third wall 117, and the fourth wall 119 may comprise another wall portion comprising a second hardness that may be equivalent to the second wall portion 127 of the first wall 113.

In some embodiments, the ribbon supporting apparatus 109 can confer several benefits related to supporting the ribbon 101. For example, the ribbon 101 can be supported on the support surface 137, with the support surface 137 defining one or more openings, for example, the first opening 147, the second opening 149, and the third opening 151. In some embodiments, the ribbon supporting apparatus 109 can comprise the one or more support channels 305 that are in fluid communication with the first opening 147, the second opening 149, and the third opening 151. When the ribbon 101 is supported on the support surface 137, a negative pressure can be generated between the ribbon 101 and the support surface 137 by evacuating air from the first opening 147, the second opening 149, and/or the third opening 151. In some embodiments, as a result of the negative pressure generated at the first opening 147, the second opening 149, the third opening 151 and the one or more support channels 305, the first major surface 103 of the ribbon 101 can be drawn into contact with the support surface 137 and maintained in a substantially fixed orientation. In some embodiments, the ribbon 101 can comprise a planar shape, though, in some embodiments, the ribbon 101 can comprise a non-planar shape (e.g., as illustrated in FIGS. 2-3, and 5-7). Due to the one or more support channels 305 extending from a center of the support surface 137 toward the edges of the support surface 137 (e.g., as illustrated in FIG. 3), the negative pressure can maintain the ribbon 101 in the substantially fixed orientation when the ribbon 101 comprises the planar shape or the non-planar shape and/or with ribbons of varying sizes.

In addition to the ribbon supporting apparatus 109 maintaining the ribbon 101 relative to the support surface 137, the walls 113, 115, 117, 119 and the support surface 137 of the ribbon supporting apparatus 109 can reduce damage to the ribbon 101 if the ribbon 101 contacts one or more of the walls 113, 115, 117, 119 or the support surface 137. For example, the first wall portion 125 of the first wall 113 (and, similarly, identical first wall portions of the second wall 115, the third wall 117, and the fourth wall 119) can comprise the first hardness. The support surface 137 can comprise the third hardness. In some embodiments, the first hardness and the third hardness may be low enough such that if the ribbon 101 contacts the first wall portion 125 of the first wall 113 (and/or identical first wall portions of the second wall 115, the third wall 117, and the fourth wall 119) and the support surface 137, the ribbon 101 may not experience damage (e.g., scratching, cracking, etc.). In some embodiments, due to the relatively low first hardness and third hardness, the ribbon supporting apparatus 109 can comprise the second wall portion 127 to protect the first wall portion 125. Likewise, in some embodiments, the second wall 115, the third wall 117, and the fourth wall 119 can comprise an identical second wall portion to the second wall portion 127 that can protect the corresponding first wall portion. In some embodiments, the second wall portion 127 can comprise the second hardness that is greater than the first hardness and the third hardness. The second hardness can allow for the second wall portion 127 to be more resistant to damage and wear than the first wall portion 125 and the support surface 137. By covering the first wall portion 125, the second wall portion 127 can shield the first wall portion 125 from the damage and wear that may occur during the polishing 207, for example, due to the polishing brush. As such, the second wall portion 127 can increase the lifespan of the ribbon supporting apparatus 109.

In some embodiments, the position of the second wall portion 127 can further protect the ribbon 101 from damage. For example, the second edge 525 of the second wall portion 127 may be offset and recessed from the first edge 509 of the first wall portion 125. As such, the first gap 201 may be formed between the ribbon 101 and the second wall portion 127. The first gap 201 can reduce the likelihood of contact between the ribbon 101 and the second wall portion 127, while also decreasing the likelihood of contact between the polishing brush and the second wall portion 127. In some embodiments, the second wall portion 127 can be replaced. For example, due to size and/or shape differences of the ribbon 101 and/or due to damage or wear of the second wall portion 127, the second wall portion 127 is detachable from the first wall portion 125. Once the second wall portion 127 is detached, the second wall portion 127 can be replaced with another second wall portion. Accordingly, the second wall portion 127 can protect the first wall portion 125 from damage, and may also be replaceable, thus prolonging the lifespan of the ribbon supporting apparatus 109. Further, the lifespan of the polishing brush can also be prolonged due to the reduced likelihood of contact between the second wall portion 127 and the polishing brush.

As used herein the terms “the,” “a,” or “an,” mean “one or more,” and should not be limited to “only one” unless explicitly indicated to the contrary. Thus, for example, reference to “a component” includes embodiments having two or more such components unless the context clearly indicates otherwise.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the endpoints of each of the ranges are significant both in relation to the other endpoint, and independently of the other endpoint.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, as defined above, “substantially similar” is intended to denote that two values are equal or approximately equal. In some embodiments, “substantially similar” may denote values within about 10% of each other, for example within about 5% of each other, or within about 2% of each other.

As used herein, the terms “comprising” and “including,” and variations thereof shall be construed as synonymous and open-ended, unless otherwise indicated.

It should be understood that while various embodiments have been described in detail relative to certain illustrative and specific embodiments thereof, the present disclosure should not be considered limited to such, as numerous modifications and combinations of the disclosed features are envisioned without departing from the scope of the following claims.

1. A ribbon supporting apparatus comprising:
a support surface defining a first plane;
a first wall portion extending along a surface edge of the support surface, the first wall portion comprising a first surface defining a second plane that is offset from the first plane, the first wall portion comprising a first hardness; and
a second wall portion extending along the surface edge and comprising a second surface attached to the first surface and a third surface defining a third plane, the second plane extending between the first plane and the third plane, the second wall portion comprising a second hardness that is greater than the first hardness.

2. The ribbon supporting apparatus of claim 1, wherein the support surface comprises a third hardness that is less than the second hardness.

3. The ribbon supporting apparatus of claim 1, wherein the support surface comprises a first opening spaced a first distance from the surface edge and a second opening spaced a second distance from the surface edge, the first distance greater than the second distance.

4. The ribbon supporting apparatus of claim 1, wherein the first wall portion comprises a first edge extending along the surface edge, the first edge defining a first edge plane.

5. The ribbon supporting apparatus of claim 4, wherein the second wall portion comprises a second edge extending along the surface edge, the second edge defining a second edge plane that is offset from the first edge plane.

6. The ribbon supporting apparatus of claim 5, wherein the support surface is on a first side of the first edge plane and the second wall portion is on a second side of the first edge plane.

7. The ribbon supporting apparatus of claim 1, further comprising:
a third wall portion extending along a second surface edge of the support surface, the third wall portion comprising a fourth surface defining a fourth plane that is offset from the first plane; and
a fourth wall portion extending along the second surface edge and comprising a fifth surface attached to the fourth surface of the third wall portion and a sixth surface defining a fifth plane, the fourth plane extending between the first plane and the fifth plane.

8. The ribbon supporting apparatus of claim 7, the second wall portion comprising a second wall height between the second surface of the second wall portion and the third surface of the second wall portion, the fourth wall portion comprising a fourth wall height between the fifth surface of the fourth wall portion and the sixth surface of the fourth wall portion.

9. The ribbon supporting apparatus of claim 8, wherein the second wall height is different than the fourth wall height.

10. A ribbon supporting apparatus comprising:
a support surface comprising a first opening spaced a first distance from a surface edge of the support surface and a second opening spaced a second distance from the surface edge, the first distance greater than the second distance;
a first wall portion comprising a first edge extending along the surface edge, the first edge defining a first edge plane; and
a second wall portion attached to the first wall portion and comprising a second edge extending along the surface edge, the second edge defining a second edge plane that is offset from the first edge plane.

11. The ribbon supporting apparatus of claim 10, wherein the support surface is on a first side of the first edge plane and the second wall portion is on a second side of the first edge plane.

12. The ribbon supporting apparatus of claim 10, wherein the first wall portion comprises a first hardness and the second wall portion comprises a second hardness that is greater than the first hardness.

13. The ribbon supporting apparatus of claim 12, wherein the support surface comprises a third hardness that is less than the second hardness.

14. A method of supporting a ribbon comprising:
forming the ribbon comprising a first major surface that is convex and a second major surface that is concave;
positioning the ribbon on a support surface bordered by a first wall portion such that the second major surface faces away from the support surface;
calculating a ribbon height of the ribbon between the first major surface and the second major surface;
selecting a second wall portion such that the ribbon height is less than a sum of a first height of the first wall portion and a second height of the second wall portion;
attaching the second wall portion to the first wall portion; and
polishing the second major surface of the ribbon.

15. The method of claim 14, wherein the positioning the ribbon on the support surface comprises attaching the ribbon to the support surface by generating a negative pressure at a plurality of locations of the support surface.

16. The method of claim 14, wherein the attaching the second wall portion comprises positioning the second wall portion a distance apart from the ribbon such that a gap is formed between the second wall portion and the ribbon.

17. The method of claim 14, wherein the attaching the second wall portion comprises positioning a second edge of the second wall portion offset from a first edge of the first wall portion, the first edge and the second edge facing the ribbon.

18. The method of claim 14, further comprising detaching the second wall portion from the first wall portion and attaching a third wall portion to the first wall portion.

19. The method of claim 14, wherein the selecting the second wall portion comprises selecting the second wall portion comprising a second hardness that is greater than a first hardness of the first wall portion.
